(19) United States
(12) Patent Application Publication
(10) Pub. No.: US 2017/0256350 A1
(43) Pub. Date: Sep. 7, 2017

(54) SOLENOID - ACTUATOR WITH PASSIVE TEMPERATURE COMPENSATION

(71) Applicant: Hanon Systems, Daejeon (KR)

(72) Inventor: Holger Menges, Walldorf (DE)

(21) Appl. No.: 15/447,311

(22) Filed: Mar. 2, 2017

(30) Foreign Application Priority Data
Mar. 3, 2016 (DE) 102016203486.3

(51) Int. Cl. H01F 7/18

(52) U.S. Cl. CPC H01F 7/18

(57) ABSTRACT

A temperature compensation circuit including a magnetic coil, wherein an electrical resistance of the magnetic coil increases with increasing temperature. The temperature compensation circuit is electrically connected to the magnetic coil and includes at least has one component whose electrical resistance decreases with increasing temperature. A plurality of components having electrical resistances decreasing with increasing temperature, increases with increasing temperature, and/or substantially constant with increasing temperature may also be provided.

### CROSS-REFERENCE TO RELATED PATENT APPLICATION

This application claims priority to German Patent Application No. 10 2016 203486.3 filed on Mar. 3, 2016, the disclosure of which is incorporated herein by reference in its entirety.

### TECHNICAL FIELD

The invention relates to a magnetic coil, for example for use in an actuator.

### BACKGROUND

Actuators or control units are used in numerous technical fields, for example to position components or actuate valves. This relates in particular to valves in the field of vehicle technology, which can be subject to extensive temperature fluctuations which also affect the actuators.

The actuators described herein include an anchor which is movable by a magnetic coil, the electrical resistance of which typically increases with temperature. As a result, the actuating force which can act on the anchor becomes lower at higher temperatures since the actuating force is dependent on the coil current. As mentioned above, since the electrical resistance of the coil increases with increasing temperature, the flowing current, and thereby the force acting on the anchor, becomes smaller. This has so far been compensated, for example, by using larger wire diameters for the coil, which leads to high currents even at comparatively low temperatures, which in turn can lead to excessive heating of the coil. Other solutions use an auxiliary coil for temperature compensation (e.g., DE 19646986), but this is cost intensive.

### SUMMARY OF THE INVENTION

Against this background, the invention is based on the object of creating a magnetic coil whose current consumption and thus also magnetic force are uniform over a wide temperature range.

This object is achieved by the magnetic coil shown and described herein.

Accordingly, the magnetic coil has a temperature compensation circuitry (temperature compensation circuit) which is electrically connected to the coil and whose electrical resistance decreases with increasing temperature. In other words, the coil has a positive temperature coefficient (PTC) so that the current decreases with increasing temperature as described above. On the other hand, the compensation circuitry has a negative temperature coefficient (NTC) so that the resistance decreases with increasing temperature. That is, the temperature compensation circuitry has at least one component whose electrical resistance decreases with increasing temperature. Such a component may be for example a heat conductive thermistor.

Overall, the behavior of an actuator provided with the magnetic coil and, in particular, the force provided can be made more uniform because the NTC behavior reduces the flowing current at comparatively low temperatures. As the temperature increases and the resistance of the compensation circuitry decreases, the resistance of the coil increases, so that a similar current continues to flow, and the provided force does not change appreciably.

In other words, a passive temperature compensation circuit is provided, and the novel magnetic coil can be used over a wide temperature range and with substantially constant current and thus, magnetic force. A passive temperature compensation circuit is understood here to be a temperature compensation circuit, which does not require any external control in order to compensate for the temperature fluctuations. Moreover, thicker wire diameters of the coil can advantageously be avoided, which leads to cost savings.

The compensation circuit is preferably designed with the aid of a circuitry simulation program in order to be able to optimally adapt its characteristic curve to the characteristic curve of the coil. In other words, the resistance of the compensation circuit decreasing with increasing temperature is adapted to the temperature behavior of the coil.

Preferred further developments are described herein.

The compensation circuitry may be a combination of resistors, at least one of which has an NTC behavior.

The compensation circuitry may be connected in series with the coil.

Furthermore, particularly good properties of the novel magnetic coil are obtained when the temperature compensation circuit is thermally coupled to the coil, so that the effects caused by the temperature changes affect the coil and the compensation circuit to the same extent, and the resistance of the coil increasing for example by temperature increases can be compensated by the resistance of the compensation circuit which decreases to the same extent when the temperature increases.

A thermal coupling is understood here to mean that the temperature compensation circuit is connected to the coil via a material which has a high thermal conductivity. Materials which are well suited for this purpose are most metals such as copper or aluminum, for example. In this case, it is advantageous if the component(s) of the temperature compensation circuit, whose resistance changes with increasing temperature, is/are directly connected to the material which carries out the thermal coupling. This ensures that they are exposed to temperature changes without further delays. If this is not the case, it may take some time for the temperature compensation to begin, since the components whose electrical resistance decreases with a temperature increase are exposed relatively late to the temperature increase.

Furthermore, the component whose electrical resistance decreases with increasing temperature may be connected in parallel with a resistor whose electrical resistance remains substantially constant with increasing temperature. A resistor whose electrical resistance remains substantially constant with increasing temperature is understood to mean a resistor whose electrical resistance value within the operating temperatures of the magnetic coil changes only within the tolerances indicated for the resistor in the event of a temperature change. This can be a “classic” ohmic resistor, as is often used in electrical circuitry.

Such a configuration has the advantage that a total resistance of the temperature compensation circuit is produced thereby, which is below the resistance value of the individual components. This has the advantage that the current flow is impeded only comparatively little. Further, by providing these two components, an increased design flexibility is ensured, that is, it is easier to provide temperature compensation with standard components for the resistor and the component whose electrical resistance decreases with increasing temperature. This can reduce costs. Furthermore, the parallel connection ensures that the maximum value of the temperature compensation circuitry, which is connected in series with the coil, is limited to the resistance value of the resistor whose electrical resistance remains constant with increasing temperature.

Similarly to the above, the two components mentioned above may be connected in series. This produces a higher overall resistance, which is advantageous in some applications. Here also, temperature compensation can be ensured with standard components, which results in a cost reduction. Furthermore, it can thereby be ensured that the temperature compensation circuitry also has a minimum value for the resistor, namely at least the value which is given by the resistor with a constant resistance during temperature increases.

It is also possible to combine the above-mentioned parallel and series circuitries, which leads to a limitation of the resistance value of the temperature compensation circuitry both upwards and downwards.

The above-mentioned series and parallel circuitries and the aforementioned combination of these circuitries also have the advantage that it is thereby possible to compensate for the typical non-linearity of the coils. Although the electrical resistance of the coils increases with increasing temperature, this increase is not linear in the temperature T and can even increase proportionally to T⁵ (so-called “Bloch T⁵ Law”). Such compensation is possible with the present circuitry, which is complicated with prior art circuitries, particularly at high currents. In this respect, the present invention offers the possibility of bypassing such problems in a simple manner, since the resistance of the overall circuitry can be influenced by the provision of a component with a constant resistance during a temperature increase.

Furthermore, a component whose electrical resistance increases with increasing temperature and which is also thermally coupled to the coil may be connected in parallel or in series with the component whose resistance decreases with increasing temperature. This configuration also has the advantage that the design margin is increased and that, if necessary, components can also be used whose electrical resistance decreases more as the temperature increases as the electrical resistance of the coil increases without this having a negative effect on the control of the magnetic coil. This also increases the design margin in the design of the circuitry and leads to the possibility of using standard components for the circuitry, which ultimately results in a cost reduction.

Furthermore, several components can be used whose electrical resistance decreases with increasing temperature. These components can be connected in parallel, in series or in a mixture of a parallel and in series circuitry, and lead to the design margin also becoming larger. Similar to the above, this leads to the fact that standard components can be used, resulting in a cost reduction. For the same reasons, it is also possible to use several resistors with a constant resistance value for temperature increases and/or several components whose electrical resistance increases with temperature increases.

### BRIEF DESCRIPTION OF THE DRAWINGS

An exemplary embodiment of the invention is explained in more detail below with reference to the drawings.

FIG. 1 shows schematically a magnetic coil according to the invention.

FIG. 2 shows, as an example, an actuator (solenoid valve) constructed with the magnetic coil according to the invention.

FIG. 3 shows a circuit diagram for a temperature compensation circuit according to one embodiment.

FIG. 4A shows a circuit diagram for a temperature compensation circuit according to another embodiment.

FIG. 4B shows a circuit diagram for a temperature compensation circuit according to a further embodiment.

FIG. 5 shows a circuit diagram for a component whose electrical resistance increases with increasing temperature and which can be used in a temperature compensation circuit according to FIGS. 3-4B.

FIG. 6 shows another circuit diagram for a component whose electrical resistance increases with increasing temperature and which can be used in a temperature compensation circuit according to FIGS. 3-4B.

### DETAILED DESCRIPTION OF AN EMBODIMENT OF THE INVENTION

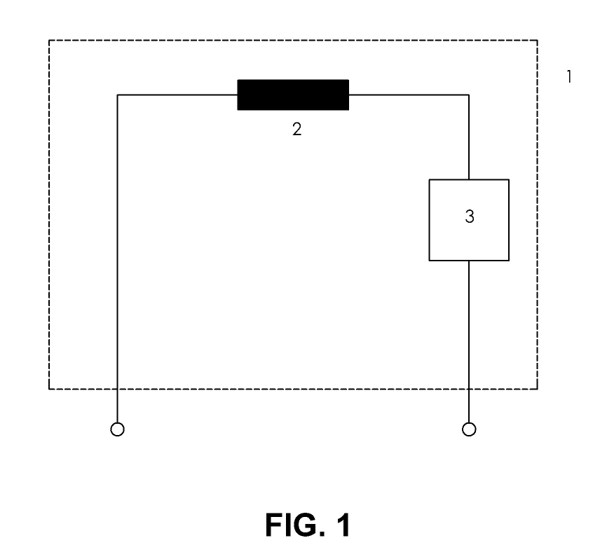

The magnetic coil 1 shown schematically in FIG. 1 has a coil 2 whose electrical resistance increases with increasing temperature. In order to compensate for this, a passive circuit 3 with NTC behavior is connected in series with the coil.

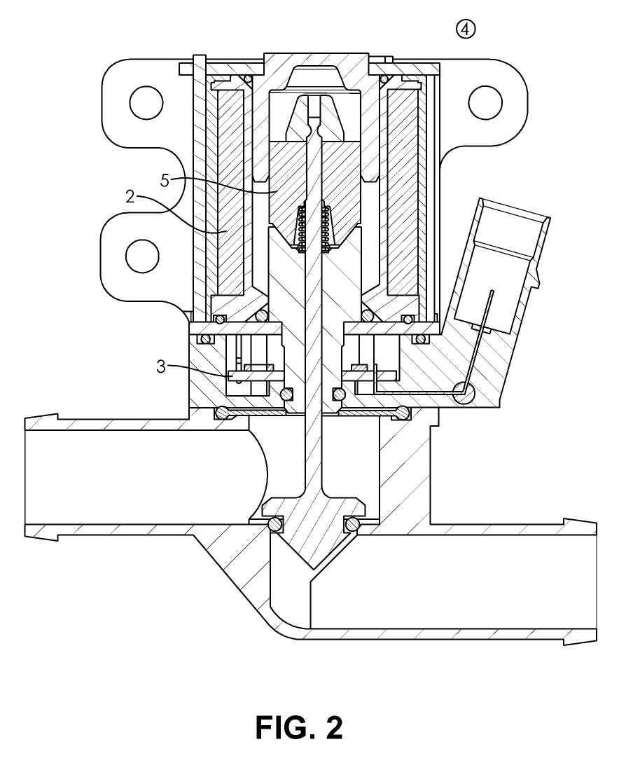

The actuator 4 shown in FIG. 2 has an anchor 5 actuated by the coil 2 and, on a circuit board, the temperature compensation circuit 3.

FIG. 2 denotes a coil, and a “bracket”, by means of which the actuator can be attached, for example. Only FIG. 2 denotes a cover, and the valve body, which is substantially Z-shaped in the case shown, wherein in the case shown the central, a short leg is substantially perpendicular to two other legs, which correspond to an inlet and an outlet. Furthermore, in the example shown, a valve tappet 5 is provided in the central leg of the “Z” in order to open or close the fluid passage. In the example shown, the valve tappet also moves substantially perpendicularly to the inlet and the outlet, and a plane of the valve seat with which the valve tappet interacts, in particular its plate provided with a seal in the case shown, is substantially parallel to the flow direction in the inlet and the outlet.

As can be seen in FIG. 2, an electronics housing, which for example has a printed circuit board with electronic components, is integrated into the actuator. In the case shown, the electronics housing is located between a base plate of the coil and the valve body 4. As can be seen in the right-hand portion of the figure, lines for the voltage supply and a switching input run from the printed circuit board to a plug-in socket, which can also be designed as a plug. It should be mentioned with respect to the structure shown in FIG. 2, in which the electronics housing is located between the coil and the valve body 4 or valve housing, that the electronics housing with the electronics provided therein, such as, e.g., a printed circuit board, electronic components, and all the components further mentioned herein, also according to FIG. 2 can be located above the coil, i.e., on the other side compared to the valve housing, or in any other way next to the coil. The last-mentioned arrangement means a displacement of the electronics housing relative to the coil in the direction perpendicular to the direction of movement of the anchor in the coil.

As shown in FIG. 2, the printed circuit board can surround the valve tappet and/or a guide provided therefore, and it can be oriented substantially perpendicular to the direction of movement of the valve tappet. The lines extending from the printed circuit board can initially be directed away from the coil, then extend substantially at an angle of 90° and extend essentially laterally alongside the coil at an angle of 70° to 90° in the direction of the coil.

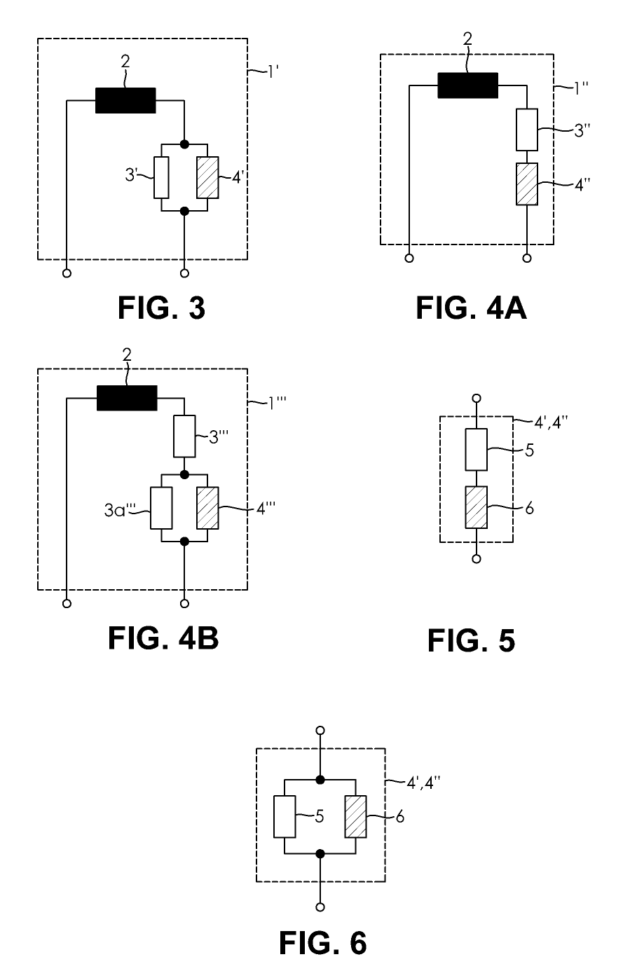

FIG. 3 shows an example of a temperature compensation circuit 1′ for an embodiment of the present invention. Here, the coil 2 is connected to a component 3′ whose electrical resistance is substantially constant with increasing temperature (e.g., a resistor), and a component 4′ whose electrical resistance decreases with increasing temperature. The component 3′ and the component 4′ are connected in parallel. Since these two components are used and they are connected in parallel, it is possible to compensate for an increase in the resistance of the coil 2 with increasing temperature. In particular, a total resistance of these two components is produced by the parallel connection of the component 3′ and the component 4′, which is lower than the sum of the resistances of these two components.

FIG. 4A shows a further example of a temperature compensation circuit 1″ for an embodiment of the present invention. In contrast to FIG. 3, the component 3″ and the component 4″, whose electrical resistance decreases with increasing temperature, are connected in series here. In this case too, by using these two components 3″, 4″ it can be ensured that the increase in the resistance of the coil is well compensated with increasing temperature. In this circuitry, the total resistance of these two components is the sum of the individual resistances, i.e., in contrast to FIG. 3, this resistance is higher than the resistance value of each individual component.

FIG. 4B shows, in a sense, a combination of the temperature compensation circuits of FIGS. 3 and 4A. In this case, a component 3a″′,whose electrical resistance is substantially constant with increasing temperature, is connected in parallel with the component 4″′, whose resistance decreases with increasing temperature. However, this parallel circuitry is connected in series with a further component 3″′, whose resistance is substantially constant with increasing temperature. For reasons which substantially follow from the above considerations of FIGS. 3 and 4A, in this case the overall resistance of this circuitry is limited both upwards and downwards.

FIGS. 5 and 6 each show examples of how the components 4′, 4″, whose electrical resistance decreases with increasing temperature, can be designed. In both cases, a component 5 is used whose electrical resistance decreases with increasing temperatures. A further component 6, whose electrical resistance increases with increasing temperature, is provided connected in parallel (FIG. 6) and connected in series therewith (FIG. 5). By providing such a component, the non-linearity of both the coil 2 and the component 5, whose electrical resistance decreases with increasing temperature, can be compensated so that the overall resistance of the circuitry consisting of coil and temperature compensation circuit remains constant in an acceptable range, ensuring good controllability. The component 6, whose electrical resistance increases with increasing temperature, can be formed here and also generally by a cold-conducting thermistor.

In this regard, it can also be useful to provide more than one component 3′, 3″, 3″′, 3a″′ with constant electrical resistance, more than one component 4′, 4″, 4″′ with an electrical resistance which decreases with increasing temperature, and more than one component 6 whose electrical resistance increases with increasing temperature. These components can each replace the components individually shown in the figures.

What is claimed is:

1. A temperature compensation circuit comprising:
a magnetic coil with an electrical coil resistance increasing with increasing temperature;
a temperature compensation circuit electrically connected to the magnetic coil; and
a first component having an electrical resistance decreasing with increasing temperature.

2. The temperature compensation circuit according to claim 1, wherein the first component is a resistor.

3. The temperature compensation circuit according to claim 1, wherein the temperature compensation circuit is connected in series with the coil.

4. The temperature compensation circuit according to claim 1, wherein the temperature compensation circuit or the first component is thermally coupled to the coil.

5. The temperature compensation circuit according to claim 1, wherein the first component is connected in parallel with a second component having a substantially constant electrical resistance with increasing temperature.

6. The temperature compensation circuit according to claim 1, wherein the first component is connected in series with a second component having a substantially constant electrical resistance with increasing temperature.

7. The temperature compensation circuit according to claim 1, wherein the first component is connected in parallel or in series with a second component with an electrical resistance increasing with increasing temperature, and wherein the second component is thermally coupled to the coil.

8. The temperature compensation circuit according to claim 1, further comprising a plurality of components having electrical resistances decreasing with increasing temperature, increases with increasing temperature, and/or substantially constant with increasing temperature.

9. An actuator comprising a temperature compensation circuit according to claim 1.
